(19) United States
(12) Patent Application Publication
(10) Pub. No.: US 2022/0125196 A1
(43) Pub. Date: Apr. 28, 2022

(54) TABLET PERSONAL COMPUTER BRACKET WITH SOFT BASE

(71) Applicant: Shenzhen Xgear Technology Co., Ltd., Shenzhen (CN)

(72) Inventor: Jie Wang, Shenzhen (CN)

(21) Appl. No.: 17/483,901

(22) Filed: Sep. 24, 2021

(30) Foreign Application Priority Data
Oct. 23, 2020 (CN) 202022387797.9

(51) Int. Cl. A47B 23/06; A47B 97/00

(52) U.S. Cl. CPC A47B 23/06; A47B 2097/006; A47B 97/00

(57) ABSTRACT

The invention relates to a tablet personal computer bracket with a soft base, comprising: a foundation and a support device. The foundation comprises a sponge inner core; the support device comprises a fixed component and a movable component, wherein the fixed component is fixedly connected to a top surface of the foundation, the movable component is provided with support plates, the support plates including an upper support plate and a lower support plate, when the movable component is tiled, the movable component, the fixed component and the support plates are all tiled on the top surface of the foundation, while in use, the support plates are supported on a back of the movable component, and the movable component, the support plates and the top surface of the foundation form a triangular support. The invention can be used on a leg.

### CROSS REFERENCE TO RELATED APPLICATIONS

The present application claims the benefit of Chinese Patent Application No. 202022387797.9 filed on Oct. 23, 2020, the contents of which are incorporated herein by reference in their entirety.

### FIELD OF INVENTION

The invention relates to a peripheral auxiliary product of a tablet personal computer, in particular to a tablet personal computer bracket with a soft base.

### BACKGROUND ART OF THE INVENTION

The development of electronic products in the present society is changing with each passing day. Mobile phones and tablet personal computers, in particular, are increasingly replacing traditional desktop computers, bearing the main functions of work and entertainment. Because of the portability of mobile phones and tablet personal computers, people like to carry them around for use. Especially when sitting on the sofa or lying on the bed to use for a long time, a person may feel his/her hands tired, and cannot change posture for a long time, so his/her cervical spine and shoulders may ache, affecting the use experience. Therefore, brackets for mobile phones and tablet personal computers are invented. Each of current mobile phone or tablet personal computer brackets is comprised of a base, a connecting piece and a clip, wherein the base is usually a counterweight disc or clamping piece configured to fix the bracket on a table top, the clip is configured to clamp a mobile phone or tablet personal computer, and the connecting piece is connected to the base and the clip. For an existing mobile phone or tablet personal computer bracket, if a base thereof is a counterweight disc, the bracket is placed on a flat upper table or ground for use, and if the base is a clip, the bracket is clamped on a table board or other similar thin board for fixing. The bracket is unable to be placed stably when used on a soft surface such as a leg, sofa or mattress, being unable to use. Modern people spend more and more time on the sofa or bed when using their mobile phones or tablet personal computers for entertainment and work. Therefore, there is an urgent need to design a mobile phone or tablet personal computer bracket which can be used on a soft load-bearing surface and can change angles at the right time, to expand use occasions and improve use experience.

### DISCLOSURE OF THE INVENTION

The purpose of the invention is to overcome the above disadvantages and defects in the prior art, and provide a novel tablet personal computer bracket with a soft base. The invention is used for placing a mobile phone or tablet personal computer. The tablet personal computer bracket of the invention can be used on a leg, which is very comfortable and convenient.

The purpose of the invention is realized by the following technical solution:

A tablet personal computer bracket with a soft base, comprising: a foundation and a support device. The foundation comprises a sponge inner core, the sponge inner core being externally wrapped by a cloth outer layer or leather outer layer; the support device comprises a fixed component and a movable component, wherein the fixed component is fixedly connected to a top surface of the foundation, the movable component is connected to the fixed component by a first flexible component, the movable component is provided with support plates, the support plates including an upper support plate and a lower support plate, the upper support plate is connected to the movable component by a second flexible component, the upper support plate is connected to the lower support plate by a third flexible component, the lower support plate is connected to the fixed component by a fourth flexible component, when the movable component is tiled, the movable component, the fixed component and the support plates are all tiled on the top surface of the foundation, while in use, the support plates are supported on a back of the movable component, and the movable component, the support plates and the top surface of the foundation form a triangular support. In this way, as the sponge inner core is externally wrapped by the cloth outer layer or leather outer layer, when the foundation including the sponge inner core is placed on a leg or placed on an uneven surface, the soft base can be shaped, can be automatically leveled by slightly pressing so that the whole bottom can be in close contact with a load-bearing surface and the whole tablet personal computer bracket with a soft base can be firmly erected on the load-bearing surface for convenient use. In this way, as the movable component, the support plates and the top surface of the foundation form a triangular support, the movable component is at a certain angle, and when a tablet personal computer is placed on the bracket, a back thereof leans against the movable component. While in use, the movable component is lifted, the flexible components at all joints are self bent, so that the movable component, the fixed component and the support plates form a triangular support. While not in use, the movable component is put down, the support plates are tiled, the flexible components at the joints are flattened, and the entire surface is tiled as a nearly flat surface, so that the integrity is good.

Another preferred solution of the invention is: a bottom of the foundation is provided with soft particles. Soft particles such as silica gel particles, TPE, TPR, EPS, EPP, EPE and latex particles are provided at the bottom, the soft particles increase a frictional force between a bottom of a cloth bag or leather bag and a support surface, preventing sliding when the bracket is used on table top or leg, being stable in use. Moreover, when the bracket is used on a human leg, the soft particles can separate the bottom of the cloth bag and a human body by a certain gap, being conducive to air circulation, avoiding heat accumulation. When the bracket is used for a long time, the human leg is not too hot, overcoming the problem of un-comfort due to heat accumulation on the leg when the bracket is used for a long time.

Another preferred solution of the invention is: a magnetic substance is provided inside the movable component, and a substance capable of attracting the magnetic substance is provided in the foundation in a relative position.

Another preferred solution of the invention is: the foundation is also provided with a blocking strip or blocking sheet. The blocking strip or blocking sheet is used to limit the tablet personal computer or mobile phone and prevent the mobile phone or tablet personal computer from sliding.

Another preferred solution of the invention is: a width of the upper support plate is different from that of the lower support plate.

When the width of the lower support plate is less than that of the upper support plate, while in use, the lower support plate is superimposed on the foundation, and the upper support plate is supported on the back of the movable component, thereby being convenient to fold. Meanwhile, the lower support plate is superimposed on the foundation, which reduces the height of the upper support plate. When supporting, the movable component can be tilted backward to a certain extent, which is convenient for the tablet personal computer to lean against the movable component. As an alternative solution, a width of the upper support plate is less than that of the lower support plate, while in use, the upper support plate is superimposed on the back of the movable component, and the lower support plate is supported between the movable component and the fixed component.

Another preferred solution of the invention is: the bottom of the sponge inner core is provided with a concave arc. The concave arc is used to place the bracket on a leg, makes the bracket not easy to shake, so that the bracket is stable and convenient to use.

Another preferred solution of the invention is: the fixed component is fixedly connected to the top surface of the foundation by Velcro or sewing. The fixing component may be firmly connected to the top surface of the foundation by sewing, being beautiful in appearance and stable in connection. The Velcro is easy to connect, so the support device can be removed, the foundation is completely used as a throw pillow, and easy to clean. The fixed connection in this solution may be to fix the fixed component to the top surface of the foundation by other common means suitable for the purpose of invention, for example, fix the fixed component to the top surface of the foundation by hook and loop fasteners, buckles, snap fasteners, screws, rivets, zippers and the like.

In the invention, when the tablet personal computer bracket is unfolded, the tablet personal computer is placed on the bracket, and the tablet personal computer is used with the back thereof against the movable component. When being folded, the bracket may be used as a throw pillow or a table board, which is very convenient and is good in use experience.

### DESCRIPTION OF DRAWINGS

FIG. 1 is a structural schematic diagram of a tablet personal computer bracket with a soft base in a folding state in embodiment 1 of the invention.

FIG. 2 is a structural schematic diagram of a tablet personal computer bracket with a soft base in a using state in embodiment 1 of the invention.

### DETAILED DESCRIPTION OF THE INVENTION

Some preferred embodiments of the invention are provided below in order to further understand the invention.

### Embodiment 1

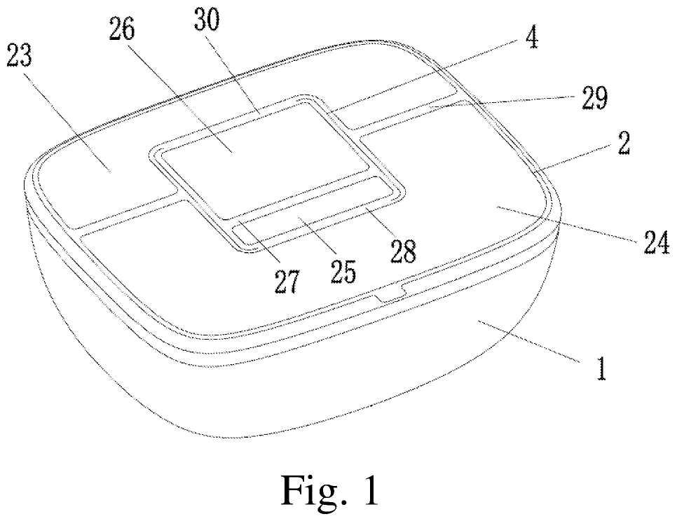

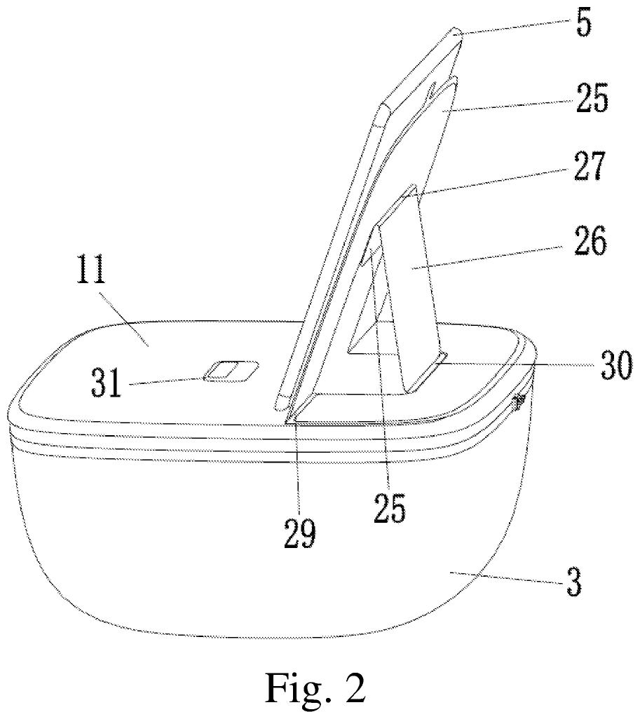

FIG. 1 is a structural schematic diagram of a tablet personal computer bracket with a soft base in a folding state in embodiment 1 of the invention. FIG. 2 is a structural schematic diagram of a tablet personal computer bracket with a soft base in a using state in embodiment 1 of the invention. As shown in FIG. 1 and FIG. 2, a tablet personal computer bracket with a soft base, comprising: a foundation 1 and a support device 2, wherein the foundation is comprised of a sponge inner core wrapped by a cloth outer layer 3; the support device comprises a fixed component 23 and a movable component 24, wherein the fixed component is fixedly connected to a top surface 11 of the foundation, in this embodiment, the fixed component is fixedly connected to the top surface of the foundation by sewing (or the fixed component may be fixed to the top surface of the foundation by hook and loop fasteners, adhesive and other means), the movable component is connected to the fixed component by a first flexible component 29, the movable component is provided with support plates 4, the support plates including an upper support plate 25 and a lower support plate 26, a width of the upper support plate being different that of the lower support plate, in this embodiment, the width of the upper support plate is less than that of the lower support plate, the upper support plate is connected to the movable component by a second flexible component 28, the upper support plate is connected to the lower support plate by a third flexible component 27, the lower support plate is connected to the fixed component by a fourth flexible component 30, as shown in FIG. 1, when the movable component is tiled, the movable component, the fixed component and the support plates are all tiled on the top surface of the foundation, as shown in FIG. 2, while in use, the support plates are supported on a back of the movable component, the lower support plate is supported on the back of the movable component, and the movable component, the support plates and the top surface of the foundation form a triangular support. The flexible components may be made of soft and bendable material such as artificial leather, PU leather, cloth or the like, which plays the role of making all flexible components bend when the movable component is lifted or the movable component is tiled, making all components relatively rotate, realizing state switching between the triangular support and the tiling.

As an improved solution, the bottom of the foundation may also be provided silica gel and other soft particles.

Further, the foundation may also be provided with a horizontal blocking strip 31 or blocking sheet. The horizontal blocking strip or blocking sheet may be provided on the top surface of the foundation, and the horizontal blocking strip or blocking sheet may be located in a coverage region of the movable component. When the movable component is unfolded, the blocking strip or blocking sheet can be used to prevent the tablet personal computer from slipping off. When tiled, the movable component is covered on the blocking strip or blocking sheet, being still a flat surface from the whole.

Further, the bottom of the sponge inner core is provided with a concave arc.

The above embodiment is a preferred implementation mode of the invention. However, the implementation mode of the invention is not limited by the above embodiment. Any other change, modification, replacement, combination and simplification made without departing from the spiritual essence and principle of the invention shall be equivalent substitution mode, and shall be included within the protection scope of the invention.

What is claimed is:

1. A tablet personal computer bracket with a soft base, comprising: a foundation and a support device, characterized in that: the foundation comprises a sponge inner core, the sponge inner core being externally wrapped by a cloth outer layer or leather outer layer; the support device comprises a fixed component and a movable component, wherein the fixed component is fixedly connected to a top surface of the foundation, the movable component is connected to the fixed component by a first flexible component, the movable component is provided with support plates, the support plates including an upper support plate and a lower support plate, a width of the upper support plate being different that of the lower support plate, the upper support plate is connected to the movable component by a second flexible component, the upper support plate is connected to the lower support plate by a third flexible component, the lower support plate is connected to the fixed component by a fourth flexible component, when the movable component is tiled, the movable component, the fixed component and the support plates are all tiled on the top surface of the foundation, while in use, the support plates are supported on the back of the movable component, and the movable component, the support plates and the top surface of the foundation form a triangular support.

2. The tablet personal computer bracket with a soft base according to claim 1, characterized in that: a bottom of the foundation is also provided with soft particles.

3. The tablet personal computer bracket with a soft base according to claim 1, characterized in that: the foundation is also provided with a horizontal blocking strip or blocking sheet.

4. The tablet personal computer bracket with a soft base according to claim 1, characterized in that: when the width of the lower support plate is less than that of the upper support plate, while in use, the lower support plate is superimposed on the foundation, and the upper support plate is supported on the back of the movable component.

5. The tablet personal computer bracket with a soft base according to claim 1, characterized in that: when the width of the upper support plate is less than that of the lower support plate, while in use, the upper support plate is superimposed on the back of the movable component, and the lower support plate is supported between the movable component and the fixed component.

6. The tablet personal computer bracket with a soft base according to claim 1, characterized in that: the bottom of the sponge inner core is provided with a concave arc.

7. The tablet personal computer bracket with a soft base according to claim 1, characterized in that: the fixed component is fixedly connected to the top surface of the foundation by Velcro or sewing.
